(19) United States
(12) Patent Application Publication
(10) Pub. No.: US 2013/0116084 A1
(43) Pub. Date: May 9, 2013

(54) Pressure Applying Mechanism for Toric-Drive Transmission

(71) Applicants: Christian McMahon, Montreal (CA); Samuel Beaudoin, Yamaska (CA)

(72) Inventors: Christian McMahon, Montreal (CA); Samuel Beaudoin, Yamaska (CA)

(73) Assignee: TRANSMISSION CVTCORP INC., Sainte-Julie, QC (CA)

(21) Appl. No.: 13/642,902

(22) PCT Filed: Apr. 29, 2011
(86) PCT No.: PCT/CA11/00505

§ 371 Date: Dec. 17, 2012

Related U.S. Application Data
(60) Provisional application No. 61/329,756, filed on Apr. 30, 2010.

(51) Int. Cl. F16H 15/12; F16H 15/38

(52) U.S. Cl. CPC F16H 15/12; F16H 15/38
USPC 476/1; 476/38

(57) ABSTRACT

A pressure applying mechanism for a toric-drive Continuously Variable Transmission (CVT) that comprises two opposed elements each with internal V-shaped ramp surfaces and at least three ball bearings interposed between the elements wherein rotation of one element causes the mechanism to expand in the longitudinal direction and thus generate an appropriate pressure between a drive disk and a driven disk. The invention further includes a pre-load mechanism comprising a washer for adjusting the pre-load on the pressure applying mechanism.

### FIELD

The present invention generally relates to toric-drive transmissions. More specifically, the present invention is concerned with a pressure applying mechanism for a toric-drive continuously variable transmission.

### BACKGROUND

Toric-drive Continuously Variable Transmissions (hereinafter generically referred to as “CVT”) are believed known in the art. The operation of such a CVT will therefore only be briefly discussed herein.

Generally stated, a toric-drive CVT is provided with a drive disk having a toroidal surface, a driven disk also having a toroidal surface, both disks being linked by rollers in contact with their respective toroidal surfaces. The angle of the rollers with respect to the drive and driven disks dictates the speed ratio between the driven and drive disks.

Such a toric-drive CVT transmission requires some kind of preloading mechanism to compress the drive and driven disks towards each other to provide a predetermined minimal friction between the disks and the rollers. A pressure applying mechanism is generally also provided to increase the pressure compressing the disks towards each other, therefore increasing the pressure between the disks and the rollers, when the CVT is in use.

### SUMMARY

An aspect of the present mechanism includes a pressure applying mechanism for a CVT provided with a longitudinal drive shaft, a drive disk and a driven disk, the pressure applying mechanism comprising:

a pressure applying element longitudinally movable onto the drive shaft; the pressure applying element having a first surface configured to contact one of the drive and driven disks and an opposite surface including at least three V-shaped double ramps;

a secondary element so mounted to the longitudinal drive shaft as to be longitudinally fixed thereonto; the secondary element having a surface facing the pressure applying element including at least three V-shaped double ramps;

at least three ball bearings interposed between the V-shaped ramps of the pressure applying and secondary elements;

a torque receiving element associated with one of the pressure applying element and the secondary element for rotational movement therewith; the other of the pressure applying element and the secondary element being so mounted to the drive shaft as to be prevented from rotating thereabout;

whereby, torque applied to the torque receiving element results in a pressure applied to the one of the drive and driven disks via a small circumferential displacement of the at least three bearings in the facing V-shaped double ramps of the pressure applying and secondary elements.

Another aspect concerns a pressure applying method to apply pressure onto the disks of a CVT provided with a longitudinal drive shaft, a drive disk, a driven disk, a preload mechanism; a pressure applying mechanism provided with a pressure applying element so configured as to apply pressure onto one of the drive and driven disks and a secondary element, the pressure applying method comprising:

adjusting the preload mechanism so that a predetermined longitudinal gap remains between the pressure applying element and one of the drive and driven disks;

upon torque detection on one of the pressure applying and secondary elements, applying pressure on one of the drive and driven disks by the pressure applying element.

Yet another aspect concerns a CVT incorporating a pressure applying mechanism.

### BRIEF DESCRIPTION OF THE DRAWINGS

In the appended drawings:

FIG. 1 is a schematic front elevation view of a dual-cavity toric-drive CVT provided with a pressure applying mechanism according to an illustrative embodiment;

FIG. 2 is an exploded perspective view of a pressure applying mechanism of the CVT of FIG. 1;

FIG. 3 is a sectional view of the toric drive CVT of FIG. 1 showing the CVT in a non-preloaded state;

FIG. 4 is a sectional view of the toric drive CVT of FIG. 1 showing the CVT in a preloaded state;

FIG. 5 is a side elevation transparent view of the pressure applying mechanism of FIG. 2;

FIG. 6 is a front view of the pressure applying mechanism of FIG. 2, shown with the drive gear and the secondary element removed;

FIG. 7 is an end view of the toric-drive CVT of FIG. 1;

FIG. 8 is a sectional view taken along line 8-8 of FIG. 7; and

FIG. 9 is a sectional view similar to FIG. 8 but schematically illustrating the pressure applying mechanism under pressure, when the toric-drive CVT is in use.

### DETAILED DESCRIPTION

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “about” is used to indicate that a value includes an inherent variation of error for the device or the method being employed to determine the value.

Other objects, advantages and features of the pressure applying mechanism for toric-drive transmission will become more apparent upon reading of the following non-restrictive description of illustrative embodiments thereof, given by way of example only with reference to the accompanying drawings.

It is to be understood that the expression “ball bearings” is to be construed, herein and in the appended claims as either conventional balls or as needle, roller, tapered roller or other types of bearings that can adequately perform the necessary function as will be described hereinbelow.

Generally stated, an illustrative embodiment of pressure applying mechanism for toric-drive transmission is concerned with a pressure applying mechanism for a toric-drive CVT where the longitudinal movement of the pressure-applying element of the pressure applying mechanism is minimal when the pressure applying mechanism shifts between a preload state and a pressure applying state.

The preload state occurs when the transmission transfers torque between 0 and a value sufficient to activate the pressure applying state. In the pressure applying state, the pressure in the system is generally the sum of the preload pressure and of the pressure applied by the pressure applying mechanism, which, in turn, is proportional to the torque being transferred by the transmission.

Since the longitudinal movements are very small between the preload and pressure applying states, the wear of the mechanical parts of the CVT are reduced, at least since the switching delays are minimized by the small movement required.

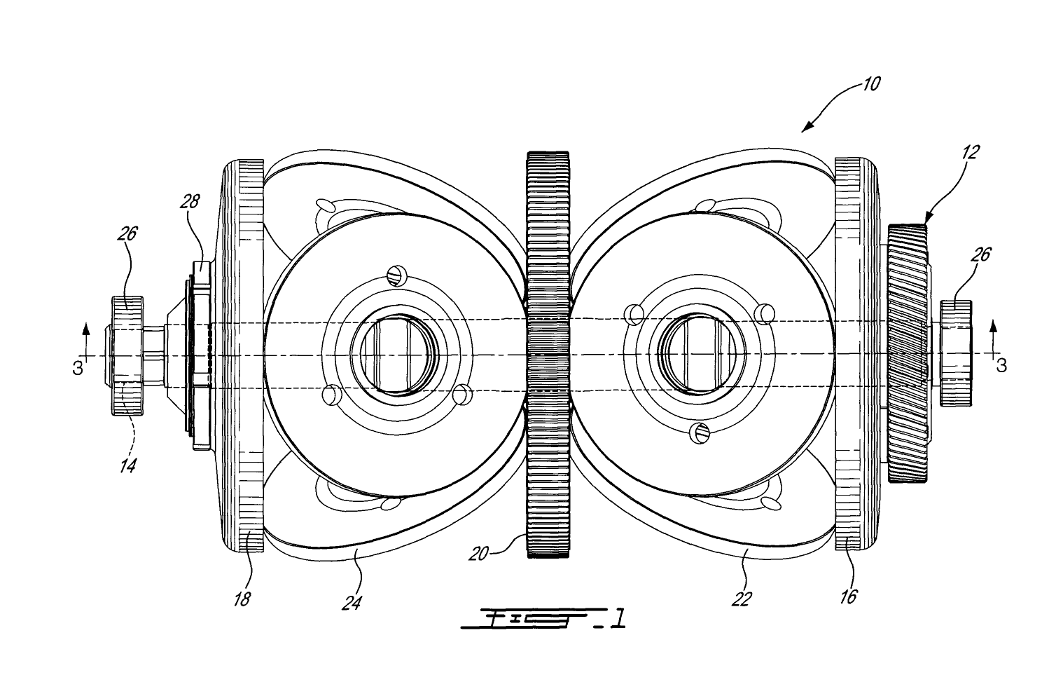

Turning now to FIG. 1 of the appended drawings, a dual-cavity toric-drive CVT 10 including a pressure applying mechanism 12 according to an illustrative embodiment will be described.

The toric-drive CVT 10 includes a longitudinal shaft 14 (shown in dashed lines) to which are mounted first and second drive disks 16 and 18 for rotation therewith. A driven disk 20 having a toothed outer surface is rotatably mounted to the shaft 14. Three rollers 22 are provided between the first drive disk 16 and the driven disk 20 while three rollers 24 are provided between the second drive disk 18 and the driven disk 20. The longitudinal shaft 14 is mounted to a casing (not shown) via bearings 26. A preload tensioning nut 28 and the pressure applying mechanism 12 are mounted near opposite longitudinal ends of the shaft 14.

It will easily be understood by one skilled in the art that the dual cavity toric-drive CVT 10 is only schematically illustrated in FIG. 1. Indeed, many subsystems such as, for example, a roller guiding subsystem, are not shown for clarity and since they have no incidence on the structure and operation of the pressure applying mechanism described herein.

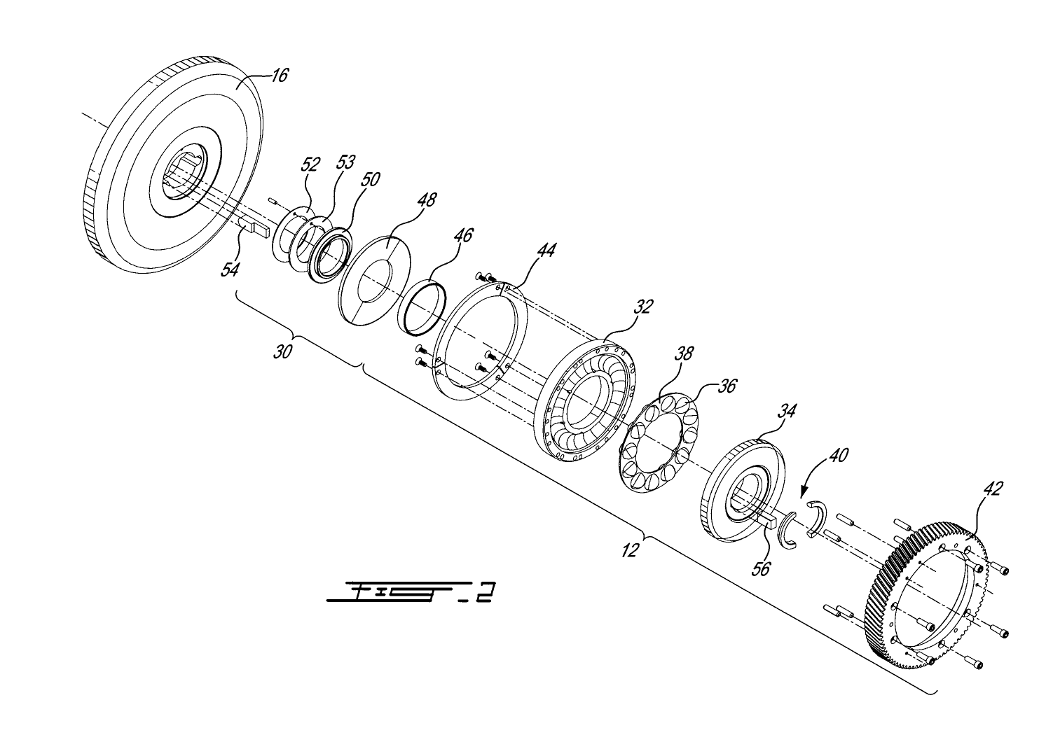

Turning now to the exploded view of FIG. 2 of the appended drawings, the pressure applying mechanism 12 and the preload mechanism 30 will be described.

The pressure applying mechanism 12 includes a pressure applying element 32, a secondary element in the form of a shaft driving element 34, a plurality of ball bearings 36 mounted in a cage 38 and provided between the pressure applying element 32 and the shaft driving element 34, a two-part longitudinal stopper 40 configured to be mounted to the shaft 14 and a gear 42 so configured as to be mounted to the pressure applying element 32. The pressure applying mechanism 12 also includes a friction-reducing disk 44 mounted to the pressure applying element 32 and a wear-preventing sleeve 46 provided between the pressure-applying element 32 and the shaft-driving element 34.

Still from FIG. 2, the preload mechanism 30 that also includes the preload nut 28 of FIG. 1 includes a Belleville washer 48, a Belleville washer centering element 50 a friction reducing disk 53 and a washer 52. The surfaces of the Belleville washer-centering element 50 and of the washer 52 facing the friction-reducing disk 53 are polished so as to reduce the wear of the friction-reducing disk 53, which is typically made of brass.

It is to be noted that the preload nut 28 and two part longitudinal stopper 40 could exchange their respective longitudinal position while performing the same functions.

A first key 54 collaborates with a keyway (not shown) of the shaft 14 to prevent rotation of the first drive disk 16 with respect to the shaft 14 while a second key 56 collaborates with a keyway (not shown) of the shaft 14 to prevent rotation of the shaft-driving element 34 onto the shaft 14.

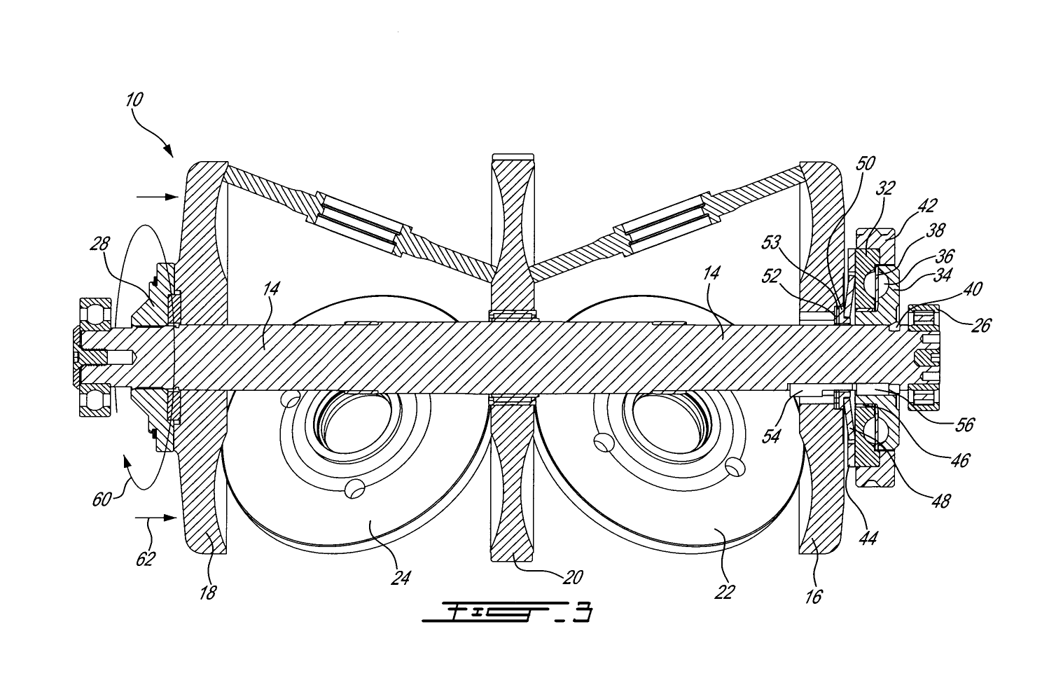

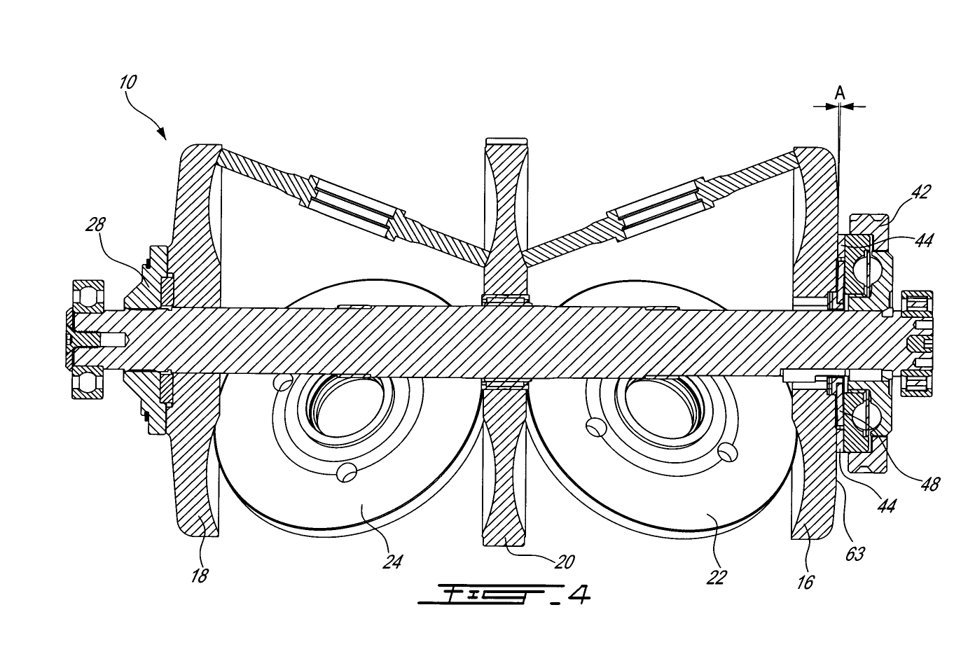

Turning now to FIGS. 3 and 4 of the appended drawings, the operation of the preloading mechanism 30 will be described.

FIG. 3 illustrates the toric-drive CVT 10 when the preload mechanism 30 is not operational, while FIG. 4 illustrates the preload mechanism 30 applying a preload pressure.

From FIG. 3, it is clear that the Belleville washer 48 is in an uncompressed state. It is also clear that the Belleville washer 48 is positioned between the Belleville centering element 50 and the pressure-applying element 32. By rotating the nut 28 (see arrow 60), the drive disk 18 is longitudinally moved onto the shaft 14 (see arrow 62), moving the rollers 24, the driven disk 20, the rollers 22 and the drive disk 16 to compress the Belleville washer 48 since the disk driving element 34 is prevented from moving longitudinally by the stopper 40.

Turning now to FIG. 4 of the appended drawings, the nut 28 is rotated until the distance “A”, which is the gap between the friction-reducing disk 44 and the outer surface 63 of the drive disk 16 is adjusted to a predetermined value. It has been found that a distance “A” of about 0.001 inch is an adequate distance for a typical toric-drive CVT application. It is interesting to keep the gap “A” as small as possible to thereby minimize the movement required when the pressure applying mechanism engages.

One skilled in the art will be in a position to select an adequate Belleville washer so that an appropriate preload pressure is applied when a small distance “A” is achieved.

Of course, other adjustment elements could be used to replace the nut 28 to adjust the gap “A” to the predetermined value. For example, the disk 18 could be mounted to the shaft 14 so as to be controllably moved longitudinally and thereafter prevented from moving longitudinally to therefore adequately preload the CVT 10.

When the toric-drive CVT is in the preloaded configuration shown in FIG. 4, it is ready to be used. More specifically, when the CVT 10 is in the preloaded configuration shown in FIG. 4, torque can be applied to the gear 42 from an external power source such as a prime mover (not shown) and transferred to the driven disk 20 via the shaft 14, pressure applying mechanism 12, the drive disks 16, 18 and the rollers 22 and 24.

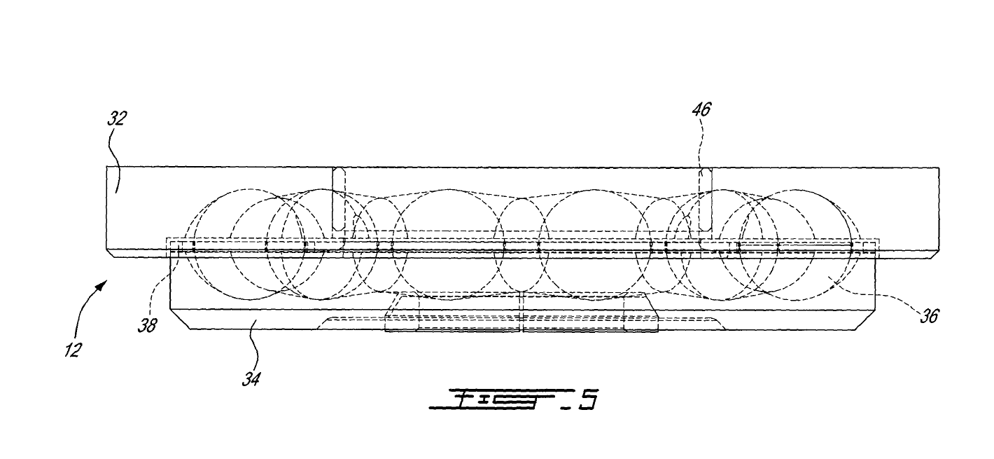

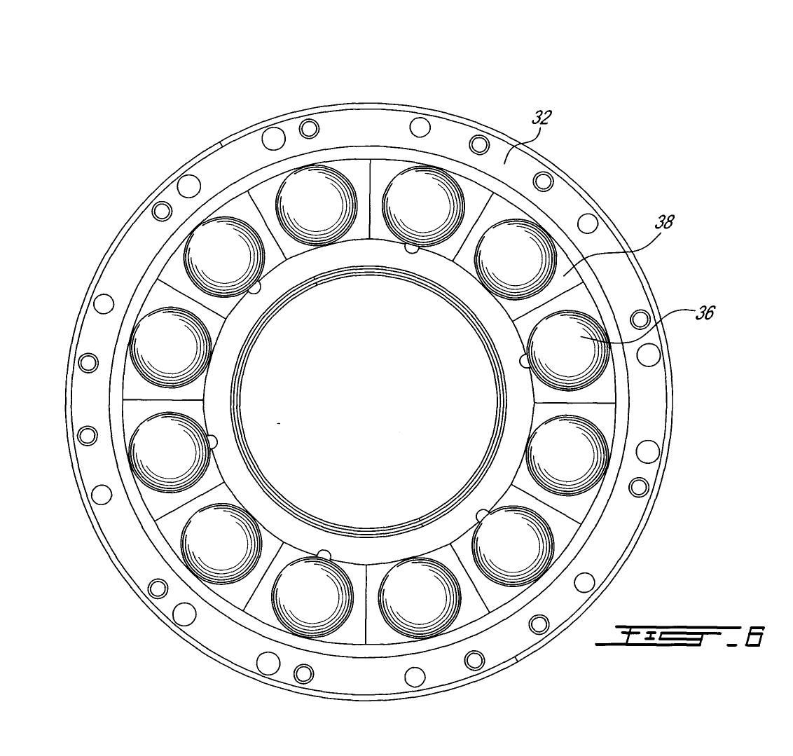

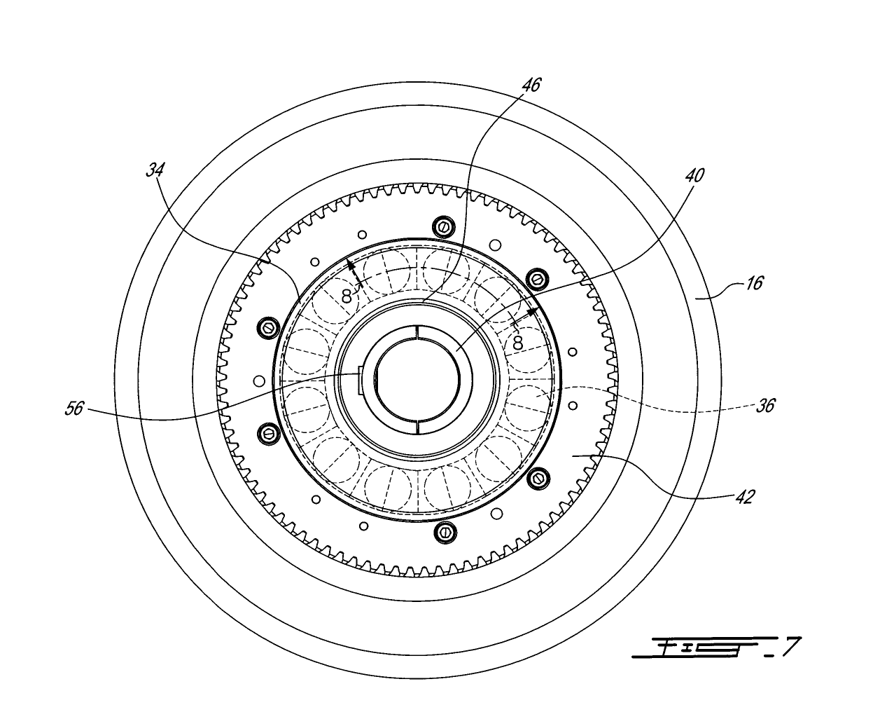

The pressure applying mechanism 12 will now be described in greater detail with reference to FIGS. 5 to 9.

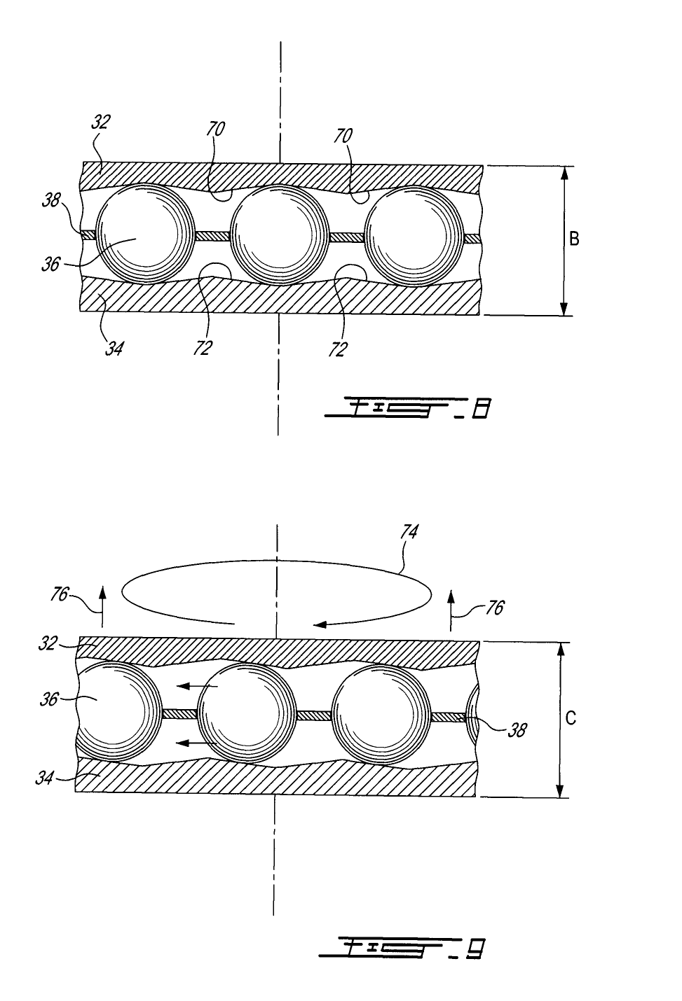

FIG. 8 illustrates a portion of the pressure applying mechanism 12 when it is in a preload configuration. When this is the case, no torque is applied to the toothed gear 42. As can be seen from FIG. 8, the surface of the pressure applying element 32 facing the shaft driving element 34 includes, for each bearing 36, a ball bearing receiving V-shaped double ramp 70. Similarly, the surface of the shaft driving element 34 facing the pressure applying element 32 includes, for each bearing 36, a ball bearing receiving V-shaped double ramp 72.

FIG. 8 shows the ball bearings 36 is a resting state, i.e. that they are positioned resting in the “bottom” of the V-shaped double ramps 70 and 72. Accordingly, the distance “B” is as small as possible.

FIG. 9 shows a portion of the pressure applying mechanism 12 when a torque is applied to the toothed gear 42, i.e. when the CVT 10 is in use. When this is the case, the torque is transferred to the pressure-applying element 32 via its connection to the gear 42. This torque is represented by arrow 74 in FIG. 9. The torque detected by and applied to the pressure applying element 32 forces the element 32 to rotate. This rotation angularly moves the pressure-applying element 32 with respect to the shaft-driving element 34 since the shaft-driving element 34 is prevented from rotating by the key 56 (see FIG. 2). Accordingly, the ball bearings 36 do not stay in the bottom of the V-shaped double ramps 70 and 72 but are moved along one side of the ramps 70 and 72 until the outer surface of the friction-reducing element 44 is in contact with the disk 16. In other words, the ball bearings 36 are moved until distance “C” generally equals distance “B” (FIG. 8) plus distance “A” (FIG. 4).

One skilled in the art will understand that since the gap “A” is adjustable via the setting of the preload mechanism 30 as described hereinabove, one can therefore adjust the amount of longitudinal movement of the pressure applying element 32 and thus the amount of longitudinal movement of the various CVT elements.

When the outer surface of the friction-reducing element 44 is in contact with the outer surface 63 of the drive disk 16, and while a torque is still applied to the toothed gear 42, this torque is transferred from the gear 42 to the shaft-driving element 34 via the ball bearings 36. At the mean time this torque transferred from the ramps 72 to the balls 36 and to the other ramps 72 generate a pressure force due to the wedging effect of the ball bearings 36 in the V-shaped double ramps 70 and 72. This pressure is applied to the disk 16 (see arrow 76) by the pressure-applying element 32.

It is to be noted that the friction between the pressure applying element 32 and the disk 16 is reduced by the friction reducing elements 44, typically made of Teflon or other friction reducing materials. Similarly, the friction between the pressure applying element 32 and the disk-driving element 34 is reduced by the sleeve 46, typically made of brass or other friction reducing materials.

It is also to be noted that the ball bearing receiving V-shape double ramps 70 and 72 are schematically illustrated in the appended figures. Indeed, the angles of the ramps have been exaggerated for illustration purpose.

One skilled in the art will understand that since the gap “A” separating the pressure applying element 32 from the disk 16 in the CVT preload state, i.e. when no torque is applied, is very small, the pressure applying mechanism 12 can react quickly and apply pressure onto the toric-drive CVT 10 to thereby reduce premature wear of the mechanical components thereof. The gap “A” being minimal it also means that the rotation movement seen from FIGS. 8 to 9 is going to be kept minimal thus reducing wear in the pressure applying mechanism.

It is to be noted that while the above disclosure describes a pressure applying mechanism where the toothed gear 42 is mounted to the pressure applying element 32 and where the secondary element, i.e. the shaft driving element 34, is keyed to the shaft 14, other configuration of these elements may be used. As a non-limiting example, the toothed gear 42 could be associated with the secondary element 34 which would not be keyed to the shaft 14 while the pressure-applying element 32 would be so keyed to the shaft 14 to allow longitudinal movement therebetween while preventing rotation thereabout. In this illustrative embodiment, the element 32 would simultaneously apply pressure onto the drive disk 16 and drive the shaft 14.

It is also to be noted that while the pressure applying element 32 is shown separate from the drive disk 16, it would be within the skills of one skilled in the art to integrate these two parts into an integrated element (not shown). Of course, should this be the case, the torque receiving gear 34 would be mounted to the secondary element 34 which would be free to rotate about the shaft. Furthermore, the preloading assembly 30 including the Belleville washer 48 would be provided between the secondary element 34 and the two-part stopper 40 which could be made more substantial.

It is also to be noted that while the disks 16 and 18 have been described herein as drive disks and the disk 20 has been described herein as a driven disk, these functions could be reversed.

Furthermore, the cam system could also be installed into the disk 20. That would require splitting the disk 20 in two disks and placing the cam, having the same ball-ramp configuration as shown herein, between the split disks. The torque applied to, or coming from, the split disk 20 would then flow through a pressure applying element 32 with similar ball ramp configuration and controlled distance A resulting once again in the generation of a longitudinal force related to the torque applied on the pressure applying element 32

It will be noted that while a dual-cavity toric-drive CVT has been described and illustrated herein, the basic principles of the pressure applying mechanism and method described herein could be applied to a single cavity toric-drive CVT.

Similarly, while a full toric-drive transmission has been shown herein, the basic principles of the pressure applying mechanism and method described herein could be applied to half toric-drive transmissions (not shown).

Also, while ball bearings have been illustrated herein mounted between the elements 32 and 34, needles, rollers or tapered rollers (not shown) could be used.

The double ramps 70 and 72 are qualified herein as being V-shaped. One skilled in the art will understand that other shapes could be used.

While the torque-receiving element has been illustrated and described as being a gear 42, other mechanical elements could be used, such as, for example a pulley, a sprocket or a direct hollowed shaft connection.

It is to be noted that the CVT described above has a pressure applying mechanism and a preload mechanism that work in parallel. More specifically, when the pressure applying mechanism is operational, the contact between the pressure applying element 32 and the disk 16 adds magnitude to the longitudinal force initially applied by the preload mechanism. Accordingly, variations in torque loads applied to the gear 42 does not cause movements of the CVT elements and therefore do not induce wear of these elements or wear of the pressure applying mechanism. It is also to be noted that since the torque must be applied to the pressure applying element before going into the CVT, the proper amount of longitudinal force to insure traction in the CVT is always present in both toroidal cavities thus insuring traction and preventing gross slip at all times.

It is to be understood that the pressure applying mechanism for toric-drive transmission is not limited in its application to the details of construction and parts illustrated in the accompanying drawings and described hereinabove. The pressure applying mechanism for toric-drive transmission is capable of other embodiments and of being practiced in various ways. It is also to be understood that the phraseology or terminology used herein is for the purpose of description and not limitation. Hence, although the pressure applying mechanism for toric-drive transmission has been described hereinabove by way of illustrative embodiments thereof, it can be modified, without departing from the spirit, scope and nature thereof.

1. A pressure applying mechanism for a CVT provided with a longitudinal drive shaft, a drive disk and a driven disk, the pressure applying mechanism comprising:
a pressure applying element longitudinally movable onto the drive shaft; the pressure applying element having a first surface configured to contact one of the drive and driven disks and an opposite surface including at least three Vshaped double ramps;
a secondary element so mounted to the longitudinal drive shaft as to be longitudinally fixed thereonto; the secondary element having a surface facing the pressure applying element including at least three V-shaped double ramps;
at least three ball bearings interposed between the V-shaped ramps of the pressure applying and secondary elements;
a torque receiving element associated with one of the pressure applying element and the secondary element for rotational movement therewith; the other of the pressure applying element and the secondary element being so mounted to the drive shaft as to be prevented from rotating thereabout;
whereby, torque applied to the torque receiving element results in a pressure applied to the one of the drive and driven disks via a small circumferential displacement of the at least three bearings in the facing Vshaped double ramps of the pressure applying and secondary elements.

2. The pressure applying mechanism recited in claim 1, further comprising a preloading mechanism.

3. The pressure applying mechanism as recited in claim 2, wherein the preloading mechanism is adjustable.

4. The pressure applying mechanism of claim 3, wherein the pressure-applying element is integral with one of the drive and driven disk of the CVT.

5. The pressure applying mechanism of claim 4, wherein the at least three ball bearings include twelve ball bearings.

6. The pressure applying mechanism of claim 5, wherein the first surface of the pressure-applying element is configured to contact the drive disk.

7. The pressure applying mechanism of claim 6, wherein the torque-receiving element includes an element selected from the group consisting of a gear, a pulley, a sprocket and a hollow shaft.

8. The pressure applying mechanism of claim 7, wherein the torque-receiving element is fixedly mounted to the pressure-applying element.

9. The pressure applying mechanism of claim 8, wherein the bearings are mounted in a cage.

10. A pressure applying mechanism of claim 9 wherein the CVT is a dual cavity full toric-drive transmission.

11. A CVT incorporating a pressure applying mechanism as recited in claim 10.

12. A pressure applying method to apply pressure onto the disks of a CVT provided with a longitudinal drive shaft, a drive disk, a driven disk, a preload mechanism; a pressure applying mechanism provided with a pressure applying element so configured as to apply pressure onto one of the drive and driven disks and a secondary element, the pressure applying method comprising:
adjusting the preload mechanism so that a predetermined longitudinal gap remains between the pressure applying element and one of the drive and driven disks;
upon torque detection on one of the pressure applying and secondary elements, applying pressure on one of the drive and driven disks by the pressure applying element.
